(19) United States
(12) Patent Application Publication
(10) Pub. No.: US 2010/0233376 A1
(43) Pub. Date: Sep. 16, 2010

(54) MECHANICAL TRACTION IMPROVEMENT APPLIED AS A LIQUID

(76) Inventor: Willaim Jardine Cook, Mission Viejo, CA (US)

Correspondence Address: William Cook, 21951 Cosala, Mission Viejo, CA, 92691, US

(21) Appl. No.: 12/720,821

(22) Filed: Mar. 10, 2010

Related U.S. Application Data
(60) Provisional application No. 61/159,370, filed on Mar. 11, 2009.

(51) Int. Cl. B05D 3/12

(52) U.S. Cl. 427/346

(57) ABSTRACT

A method of application of a traction enhancer to a drive wheel is described. The traction enhancer can improve the grip of the wheel on a stationary surface. The method can comprise applying liquid material to cover the circumference of the wheel; and allowing the wheel to turn until the material cures.

### RELATED APPLICATIONS

The present application claims benefit of priority from U.S. Provisional Application No. 61/159,370, filed Mar. 11, 2009, which is incorporated herein by reference in its entirety.

### BACKGROUND OF THE INVENTION

The present invention generally relates to mechanical traction and, more specifically, to a method to improve the traction of wheels on model railroad engines.

Small mechanical drives can suffer from inadequate mechanical traction of their wheels. In the example of model railroads, the drive wheels often slip under load due to inadequate traction, limiting users to a shorter than preferred train.

As can be seen, there is a need for a method of improving mechanical traction.

### SUMMARY OF THE INVENTION

One aspect of the present invention is a method of providing mechanical traction to a wheel comprising applying material in liquid form to cover a drive surface of the wheel; and allowing the wheel to turn until the material cures to form a wheel coated on the drive surface with cured material.

Another aspect of the present invention is a method of providing mechanical traction to model train locomotive drive wheels comprising rotating the drive wheels; using an applicator to apply a coat of liquid material to cover the circumference of the drive wheels; and allowing the wheels to rotate until the liquid material cures.

These and other features, aspects and advantages of the present invention will become better understood with reference to the following drawings, description and claims.

### BRIEF DESCRIPTION OF THE DRAWINGS

FIG. 1 is a flowchart of an exemplary embodiment of the invention as applied to a model railroad engine;

FIG. 2 is a side view of an exemplary embodiment of the invention illustrating the rotation of the wheels when applying the liquid material;

FIG. 3 is a section view of the exemplary embodiment of the invention taken along line 3-3 in FIG. 2 illustrating the uncured, properly applied liquid material; and

FIG. 4 is a detail section view illustrating the fully cured material in the exemplary embodiment of FIG. 3.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention generally provides a method of application of a traction enhancer to a drive wheel to improve the grip of the wheel on a stationary surface. BULLFROG SNOT™ is an example of a liquid material 12 that can be applied to the drive wheels. After curing it can provide a thin gripping surface for making contact with the metal track.

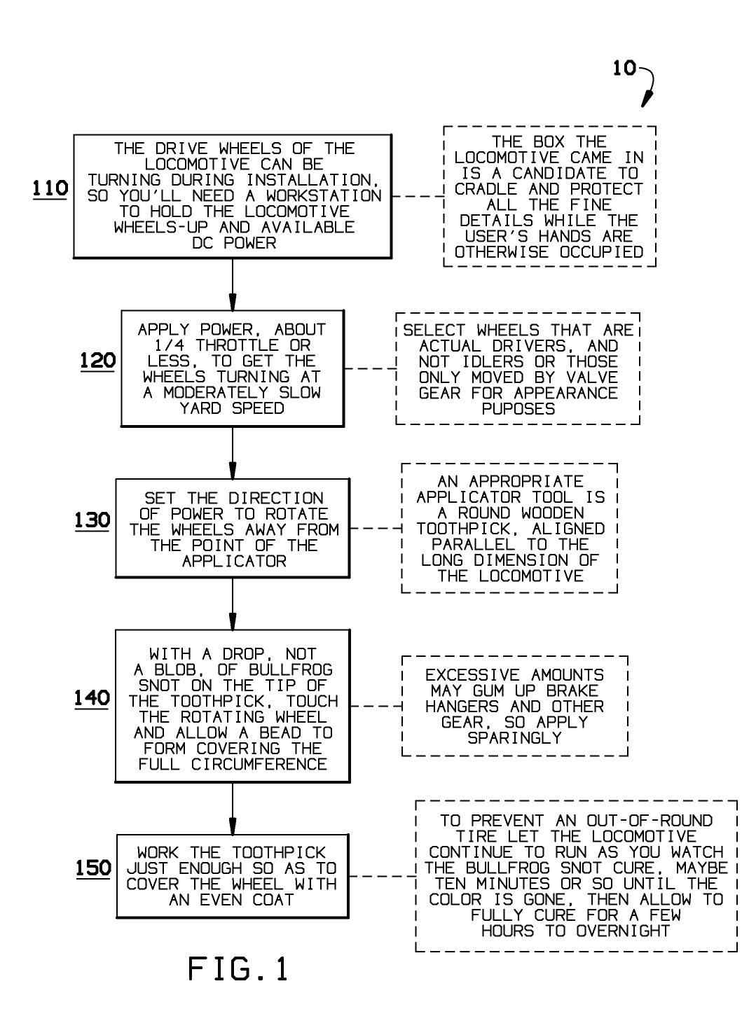

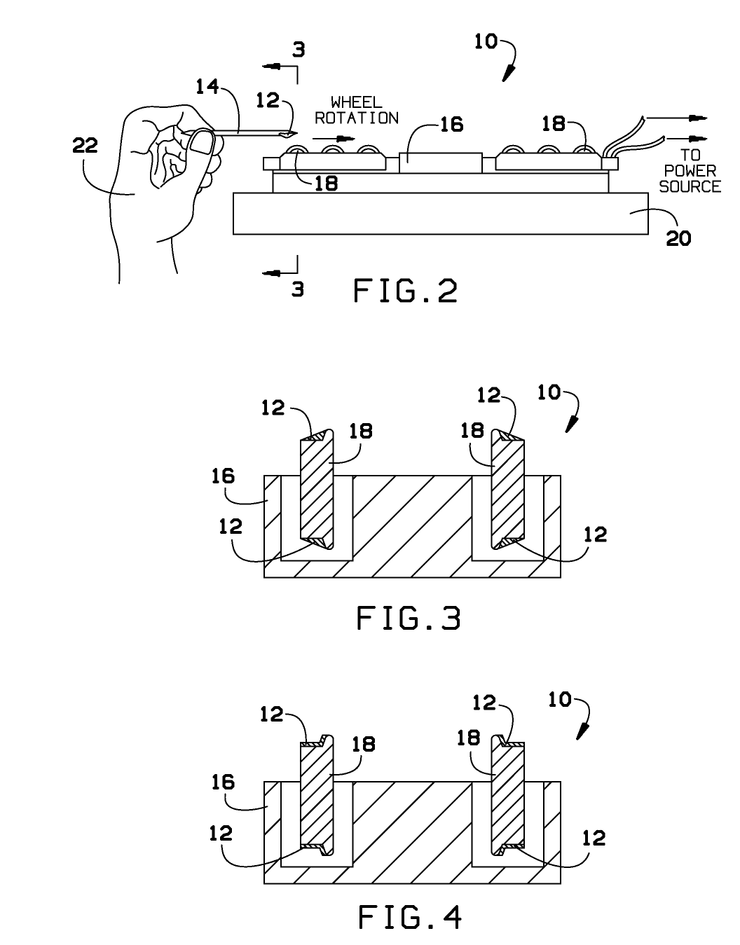

An exemplary embodiment of the method may comprise the following steps (FIG. 1). In step 110, it can facilitate even application of liquid material 12 to drive wheels 18 if the drive wheels 18 of the locomotive 16 are turning during installation. For example, a user can use a work station 20 to hold the locomotive 16 wheels-up, and can use available DC power to run the engine of the locomotive 16 (see FIG. 2). In step 120, power can be applied to get the drive wheels 18 turning at a moderately slow speed. In step 130, the direction of power can be set to rotate the drive wheels 18 away from the point of the applicator 14. An appropriate applicator tool 14 can be a round wooden toothpick, aligned parallel to the long dimension of the locomotive 16, although other suitable tools or automated application can be used. In step 140, with a drop of BULLFROG SNOT™ or other suitable material 12 on the tip of the applicator 14, a user can touch the rotating wheel 18 and allow a bead to form covering the full circumference (see FIG. 3). In step 150, the applicator 14 can be manipulated just enough as to cover the drive surface of wheel 18 with an even coat. To prevent an out-of-round tire, the drive wheel 18 can be allowed to continue to turn while the material 12 cures to a non-liquid state. The wheel can then be allowed to stop, and the material 12 may be allowed to fully cure as necessary. Typically the liquid material 12 can be colored in its uncured state thus providing an easy visual check on the thoroughness of application. For example, BULLFROG SNOT™ in its uncured state is a green color, and it goes on thickly, hence it can be easy to see where it has been applied so the user can check the work. As the BULLFROG SNOT™ cures, it can form a thin and tight coating on the drive wheel 18, as shown in FIG. 4.

BULLFROG SNOT™ is an example of a commercially available specially formulated room temperature curing one-part green liquid plastic with properties that can allow it to stick to metal drivers and retain a tactile grip like a race car tire. The BULLFROG SNOT™ can cure at room temperature and remain pliable in application. It can be easily applied, and easily removed. It is ready to use without multi-part mixing. No disassembly of the drive mechanism is required, and no special tools or skills may be required for the instant method. BULLFROG SNOT™ can cure at room temperature in moments with no baking or noxious fumes. The coloring provided in the BULLFROG SNOT™ can make it easy to see the work, and BULLFROG SNOT™ can cure clear to virtual invisibility with a thickness of 0.0055″ or less when cured. The method can work for a variety of model locomotives from a variety of manufacturers in a variety of scales.

Alternative embodiments of the instant invention include improving mechanical traction or grip to any surface or application where a traction improvement may be needed. Examples of applications where an improvement in traction between objects may be desirable include, but are not limited to, rotating drive wheel contacted to stationary object rails, stationary drive wheel contacted to movable object (such as the positioning drive of an instrument, drive wheel to driven wheel, sewing machines, slot car racers, and the like).

It should be understood, of course, that the foregoing relates to exemplary embodiments of the invention and that modifications may be made without departing from the spirit and scope of the invention as set forth in the following claims.

We claim:

1. A method of providing mechanical traction to a wheel comprising:
applying material in liquid form to cover a drive surface of the wheel; and
allowing the wheel to turn until the material cures to form a wheel coated on the drive surface with cured material.

2. The method of claim 1 wherein the liquid material cures to a smooth, thin and even layer.

3. The method of claim 1 further comprising contacting the wheel coated on the drive surface with cured material to a movable object.

4. The method of claim 1 further comprising contacting the wheel coated on the drive surface with cured material to a rail.

5. The method of claim 4 further comprising holding the rail stationary and allowing the wheel coated on the drive surface with cured material to move along the rail.

6. A method of providing mechanical traction to model train locomotive drive wheels comprising:
rotating the drive wheels;
using an applicator to apply a coat of liquid material to cover the circumference of the drive wheels; and
allowing the wheels to rotate until the liquid material cures.

7. The method of claim 6 wherein rotating the drive wheels is accomplished by applying electric power to an engine in the locomotive wherein the engine is connected to the drive wheels.

8. The method of claim 6 wherein rotating the drive wheels is accomplished by applying an external force.

9. The method of claim 6 wherein the liquid material cures to a thin and even layer.
